(19) United States
(12) Patent Application Publication
(10) Pub. No.: US 2009/0136329 A1
(43) Pub. Date: May 28, 2009

(54) Electric Motor Driven Lift For Vehicle Wheel

(76) Inventor: Curtiss L. Roberts, Orlando, FL (US)

Correspondence Address: James H. Beusse, Esquire;Beusse Wolter Sanks Mora & Maire, P.A., Suite 2500, 390 North Orange Avenue, Orlando, FL, 32801, US

(21) Appl. No.: 12/274,112

(22) Filed: Nov. 19, 2008

Related U.S. Application Data
(60) Provisional application No. 60/990,508, filed on Nov. 27, 2007.

(51) Int. Cl. B65G 69/34

(52) U.S. Cl. 414/401

(57) ABSTRACT

A wheeled dolly adapted for transport and support of a vehicle wheel includes a base unit having a plurality of vertical, tubular support posts, with each of the posts terminating in a roller arranged to allow the base unit to be moved across a surface. A platform is adjustably attached to a top of the base unit and the platform includes a plurality of downwardly extending tubular posts sized and positioned to telescopically engage the support posts of the base unit. A top surface of the platform is configured to support a vehicle tire in an upright position. An electric motor and drive mechanism is coupled between the platform and the base unit such that operation of the motor and drive mechanism can lift and lower the platform through a predetermined distance. The drive mechanism uses an adjustable telescopic coupling between the platform and base unit to extend the range of movement between the platform and base unit.

### SPECIFIC DATA RELATED TO THE INVENTION

This application claims the benefit of U.S. Provisional Application No. 60/990,508 filed Nov. 27, 2007.

This invention relates to a portable dolly for supporting and transporting a vehicle wheel that is being removed from or bolted onto a vehicle that is supported on a lift.

The present invention is directed to a wheel lift or dolly which can be used by a mechanic or other person working on a vehicle in which the vehicle has been raised above ground level by a lift. For example, the vehicle may be in a garage and be elevated so that the wheels of the vehicle are approximately chest high to the person working on the vehicle. In this case, removal of a wheel in order to gain access to components of the vehicle hidden behind the wheel requires the mechanic or other person to remove the lug nuts holding the wheel to the vehicle and then to physically lift the wheel and lower it to the ground. In today's vehicles, the wheels on ordinary passenger vehicles have grown to be as large as twenty inch diameter and can weigh seventy or more pounds. This weight creates a risk of injury to the person lifting the wheel due to the awkwardness of the lifting and removal of the wheel from the vehicle and to the replacement of the wheel on the vehicle while the vehicle is in the raised position.

A number of wheel dollies have been illustrated in the prior art. See, for example, the apparatus described in U.S. Pat. No. 7,334,804 and the patents cited therein. Some of these devices incorporate a hydraulic jack while others use a manual jack to raise a platform into position adjacent a wheel. One issue with the prior art devices is an inability to precisely position the dolly in support of the wheel such that pressure is released from the lug bolts holding the wheel to the vehicle during removal of the wheel and to accurately align the wheel with the lug nut holes during attachment of the wheel to the vehicle. In general, even with these prior art dollies using hydraulic jacks, it is generally been found that the mechanic or other person lifting the wheel must expend some effort to raise the wheel in order to have the wheel aligned with the lugs on the vehicle.

### SUMMARY OF THE INVENTION

The present invention overcomes the disabilities of the prior art in positioning of a lifting device or dolly to support a wheel for a vehicle by incorporating an electric motor actuated device that allows for precise positioning of the dolly height with respect to a wheel. The motor uses a gear box to drive a threaded shaft in an axial direction of the motor such that the shaft operates to create a displacement between the motor and the end of the shaft. The invention comprises a base unit and an attached platform adapted for supporting a vehicle wheel. The motor is connected to the platform and the threaded shaft is connected to the base unit such that the platform can be raised and lowered with respect to the base unit. The shaft and motor are configured to provide only a limited amount of movement of the platform with additional displacement being afforded by telescoping arrangement of posts supporting the platform to the base unit. In an exemplary form, the base unit uses four corner posts and the platform has four mating corner posts that telescope into the posts of the base unit. The post of both the base unit and the platform having mating holes that are uniformly spaced so that the relative position between the platform and base unit can be fixed by pins passing through aligned holes in the mating posts. The shaft of the motor is similarly coupled to the base unit using another cylindrical post so that the shaft can be pinned to the post allowing reaction between the shaft and post to lift the platform.

In operation, the motor is actuated to lift the platform until a pair of holes in the mating posts of the platform and base unit are aligned. Pins are then inserted into the mating holes and the motor shaft retracted while the platform is supported on the pins. The motor shaft connection to the cylindrical post is then adjusted so that the shaft can again be used to lift the platform. The top of the platform may also be provided with a removal tray to allow the dolly to be used to support objects other that a wheel.

### BRIEF DESCRIPTION OF THE DRAWINGS

FIG. 1 is a simplified view of the dolly of the present invention positioned in relationship to a vehicle for use in removing a wheel;

FIG. 2 is front perspective view of the dolly of FIG. 1 showing the general construction of the dolly;

FIG. 3 is a front view of the dolly of FIG. 2 showing the pin support arrangement for explaining the sequential lift function of the dolly;

FIG. 4 is a partial cross-sectional view of a portion of the dolly of FIG. 2 illustrating electrical wiring and hollow tube construction;

FIG. 5 is a simplified cross-sectional view of the lift motor and shaft for electrical operation of the dolly lift function;

FIG. 6 is a partial view of the dolly of FIG. 2 showing how a wheel seats on the platform and is held in position for transport by an elastic strap;

FIG. 7 is a perspective view of the platform portion of the dolly illustrating use of a removable tray; and

FIG. 8 is a front view of FIG. 7 showing engagement of the tray to the platform.

### DESCRIPTION OF THE PREFERRED EMBODIMENT

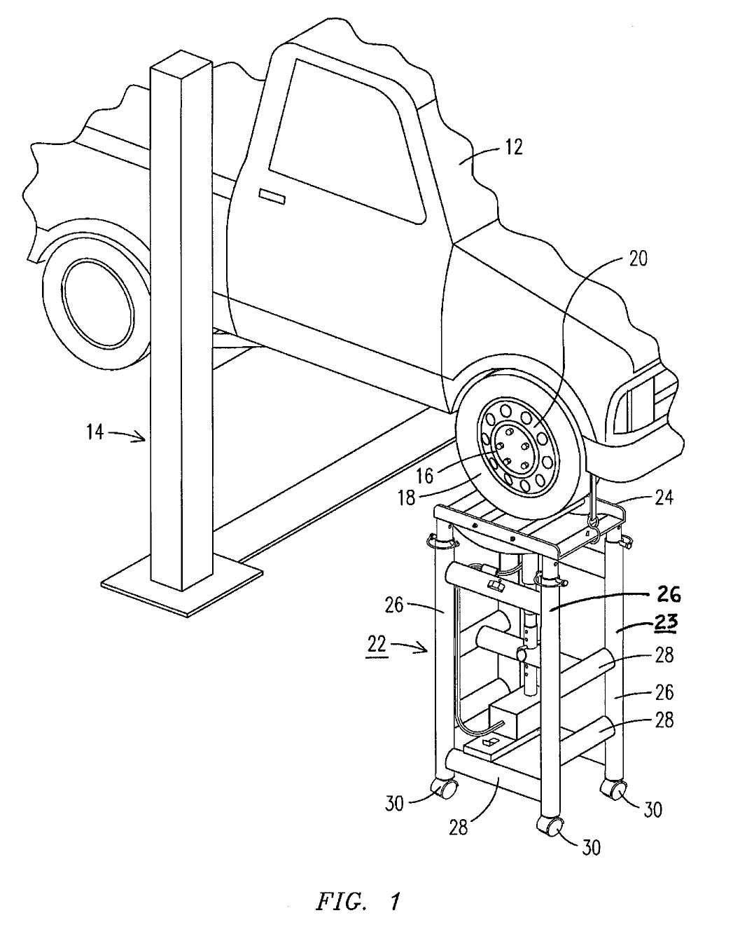

Referring now to FIG. 1, there is shown a simplified partial view of a vehicle 12 positioned on a conventional lift indicated at 14 such that a wheel 16 of the vehicle is raised to a height approximately at the chest of a person who would be working to remove the wheel from the vehicle. For purposes of this description, the wheel will be defined as including both the tire 18 and a metal hub 20 on which the tire is mounted. The lift or dolly of the present invention is indicated generally at 22.

The dolly 22 includes an upper portion or platform 24 that is supported on a base unit 23. The base unit is constructed with four corner posts 26 although other numbers of posts could be used so long as the base unit is free standing. Further, the posts could be arranged in a different pattern than at the corners as illustrated. The corner posts 26 are interconnected by means of cross members 28. Preferably, each of the posts 26 terminates in a roller 30, which may be any of the several types of rollers, including wheels, that are commercially available to enable the dolly to be rolled on the floor of a garage. Rollers 30 are attached in a conventional manner. The top surface of the platform 24 is configured to support the vehicle wheel in the upright position as shown in FIG. 1.

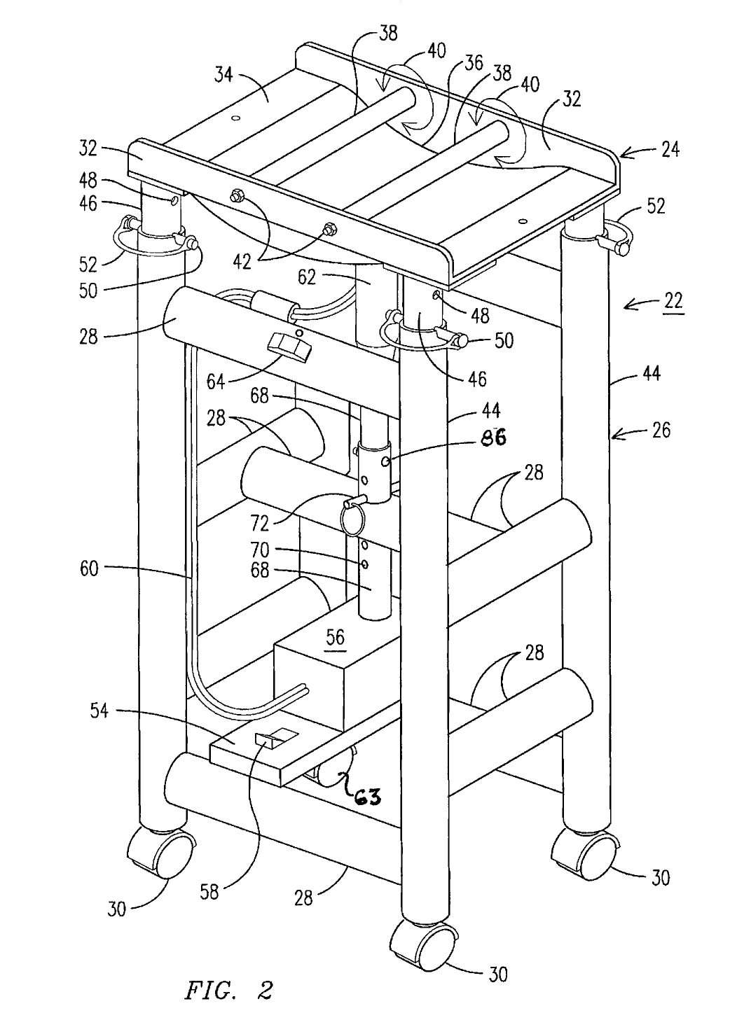

Turning now to FIG. 2, there is shown an enlarged view of the dolly 22 of FIG. 1. In this view, it can be seen that the upper platform 24 comprises a pair of metal side plates 32 and a bottom pan 34 that incorporates a curved section 36. The curved section of the pan 34 provides a depressed area in the center allowing a pair of rollers 38 to be extended crosswise between the opposite side support members 32. The rollers 38 rotate as shown by arrows 40 to allow a tire positioned on the rollers to be rotated about its axis. The rollers 38 may be attached to the side members 32 by means well known in the art such as by passing a large bolt through the rollers and the side members and fastening with nuts 42.

FIG. 2 also illustrates that the vertical support members 26 comprise an outer cylindrical member 44 and an inner cylindrical member 46. The members 44 and 46 form a telescoping arrangement that allows the platform 24 to be lifted above the height of the outer members 44. Each of the inner members 46 is provided with a plurality of holes 48 through which a pin 50 can be inserted in order to support the elevated position of the members 46 with respect to the outer members 44. Each of the pins 50 is provided with a tether 52 to prevent them from being inadvertently removed from their position through the holes 48. The upper ends of the members 44 may include a slot for seating of the pins 50 or holes may be provided through members 44 for the pins 50.

In a preferred embodiment, each of the support members 26 including both the outer cylindrical member 44 and the inner cylindrical member 46 are formed of metal to provide the required support and indestructibility of equipment needed in a garage operation. However, it is recognized that new developments in plastics may result in there being plastic materials that could be substituted for the metal supports. In the illustrated embodiment the metal supports 44 are joined together by metal cross brace members 28 that are welded at their ends to the members 44. Preferably, each of the cross brace members 28 is a tubular member so as to minimize the weight of the dolly 22.

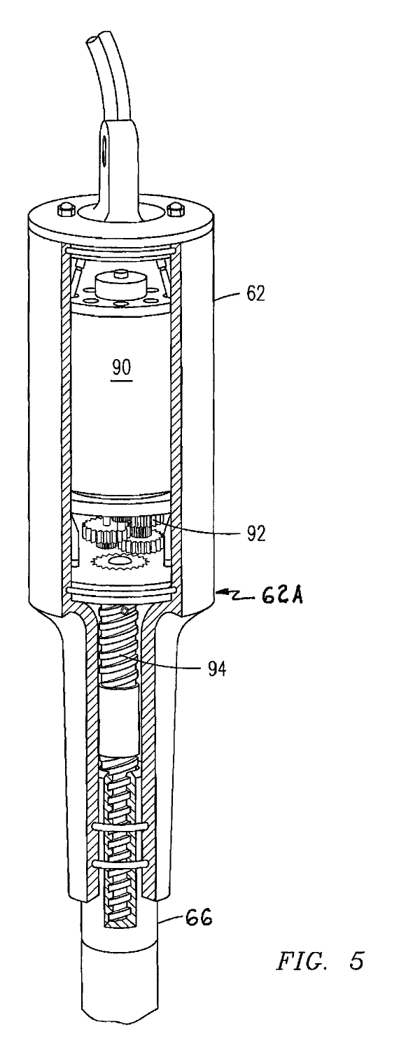

In the form illustrated in FIG. 2, there is provided a lower mounting housing 54 extending across the two lowest cross members 28 and attached thereto. Mounted on the housing 54 is a electrical junction box 56. An electrical master switch 58 is also attached to the housing 54 with the associated electrical conductors extending within the 54 and into the box 56. The master switch 58 may be utilized to turn off all power at the dolly 22. As previously mentioned, the raising and lowering of the platform 24 is accomplished by an electric motor drive assembly. For this reason, the box 56 may include electrical connections for supplying power to the dolly from a conventional AC source in a shop. It will be recognized that the motor may be an AC or a DC motor. In the case of a DC motor, the box 56 would include circuitry for converting external AC poser to DC power. Similarly, if the box 56 is adapted to contain batteries for driving the motor, rectifying circuitry may be included to enable recharging of the batteries from an AC source. The design and construction of motor drive circuitry for either an AC motor or a DC motor are well known in the motor art. It may be advantageous to use a DC motor adapt the box 56 to receive rechargeable batteries that can be used to power the electric motor in the dolly so as to avoid the need for having to run cords from the dolly to an AC outlet. Electric power is supplied from the box 56 via the electric lines 60 coupled from the box to the electric motor illustrated generally at 62. A conventional starter circuit for the motor 62 is associated with the box 56 and housing 54 with a starting capacitor indicated at 63. A directional control switch 64 is mounted to one of the upper brackets 28 and allows the power to the motor 62 to be applied in a manner to either raise the platform 24 or lower the platform 24. In essence, the switch 64 may be a rocker switch or a slide switch that enables power to be applied to the motor 62 to control the direction and amount of lift created by the motor. It should also be noted that the motor 62 incorporates an elongate shaft 66 which extends downward from a drive mechanism 62A (see FIG. 5) into another outer shaft 68. Both the outer shaft 68 and inner shaft 66 are provided with matching holes 70 through which a pin 72 can be inserted. The spacing between the holes 70 is set to a small distance encompassing the range of motion of the shaft 66 being driven by the motor 62. In other words, if the motor 62 is capable of advancing the shaft 66 approximately two inches, then the spacing between the holes 70 in a vertical direction would be selected to be approximately two inches. This allows the height of the platform 24 to be adjusted to within two inches of its final desired height and the motor to be used to make fine adjustments to the position of the platform 24 so as to accurately position the height of a wheel being removed from or placed on the vehicle.

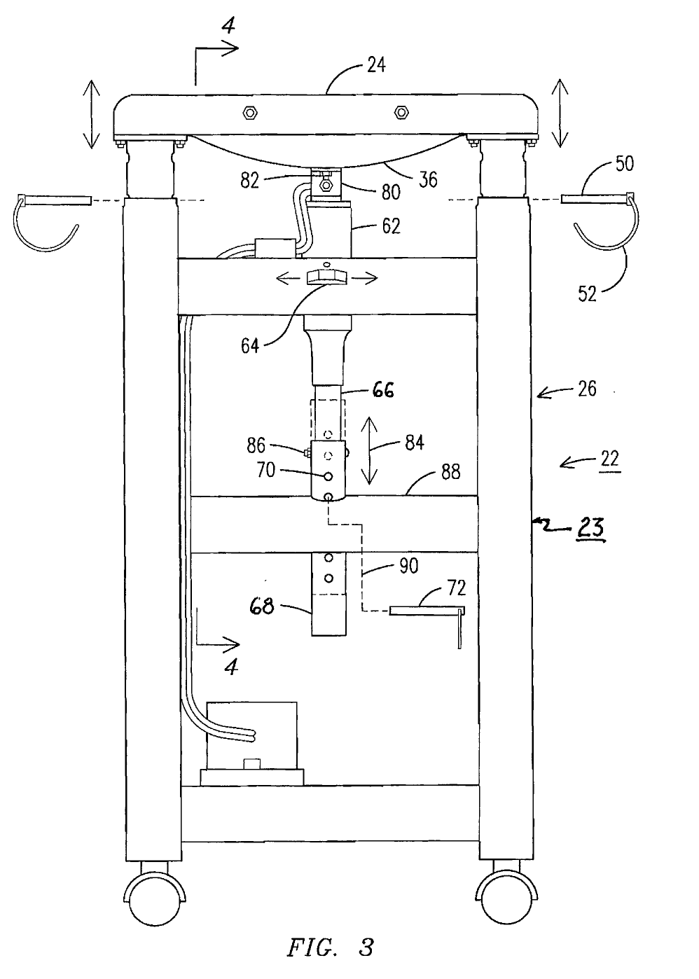

Referring now to FIG. 3, there is shown a front view of the dolly 22. This view illustrates more clearly the operation of the lifting and lowering of the platform 24 with respect to the support members 26. The motor drive assembly 62 is bolted or otherwise fixed to the underside of the platform 24 at the curved section 36. The fastening may be done by means of a coupling 80 attached to the bottom of the curved section 36 by means of nut and bolt assemblies 82. This arrangement fixes the position of the motor section 62 with regard to the platform 24. The shaft 66 extends from an opposite end of the motor 62 and is moveable in a vertical direction as indicated by the arrow 84. Shaft 66 is vertically movable via a screw drive arrangement within the motor 62 housing as is more fully shown in FIG. 5. The shaft 66 is telescopically mounted in a second outer shaft 68 so that the shaft 66 may telescope within the shaft 68. During operation of the motor 62, the shaft 68 and 66 are bolted together as indicated by bolt 86 so as to fix the shaft 68 to shaft 66 and to essentially create an extension of the shaft 66 supported on cross-member 88. The shaft portion 68 extends through a hole formed in the cross member 88 and the pin 72 fits through the hole 70 to provide a support for the shaft 68 against cross member 88. It will be appreciated that if the pin 72 is placed in the one of the holes 70 indicated by the dashed lines 90, the actuation of the motor 62 to raise the platform will cause a reaction of the pin 72 against the cross member 88. As the platform 24 is raised by operation of the motor 62, the inner supports 46 within the outer supports 44 will telescope outwardly allowing the platform to be raised. The pins 50 can then be placed through the hole 48 in the inner member 46 so as to support the platform 24 at a desired height. The platform 24 may be smoothly adjusted between the distances represented by adjacent pairs of the holes 70 by use of the motor 62. For adjustments beyond that range, the system utilizes a sequence of raising and lowering with placement of the pins 50 and 72 to allow the platform to be adjusted to any desired height. For example, with the pins 50, 72 inserted in the locations shown in FIG. 3, the platform 24 can be raised by motor 62 and shaft 66 until pins 50 can be removed and inserted into the next set of holes 48. The motor 62 is then operated in a reverse direction to withdraw shaft 66 toward the motor while the platform is supported by the pins 50. The pin 72 is then withdrawn and reinserted into a new position and the motor again operated in a forward direction to lift the platform using reaction of the shafts 66,68 combination against member 88 at the new position of pin 72. In this manner, the platform 24 can be raised or lowered in a series of steps while the position between each of the steps or pin positions is accurately controlled by use of the electric motor 62.

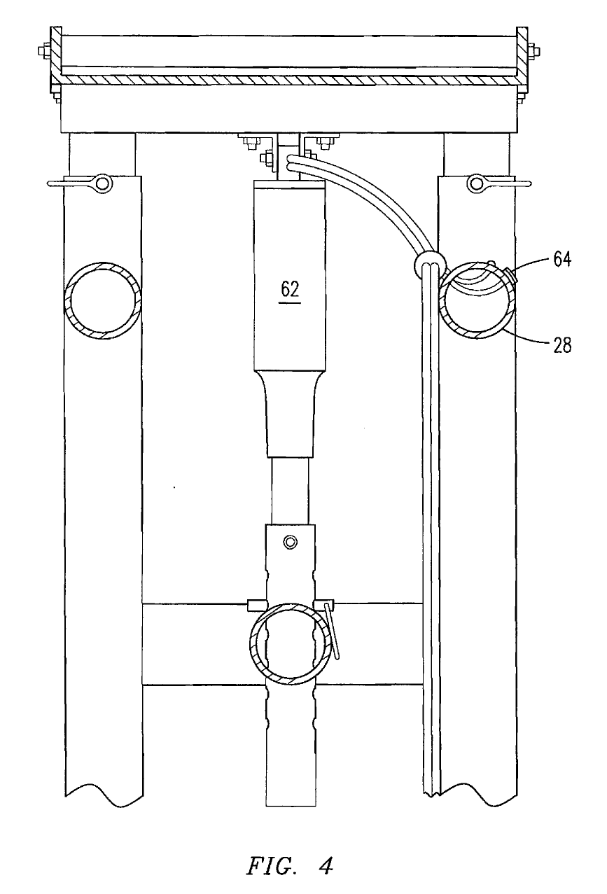

FIG. 4 is provided to illustrate how the electrical connections extending from the connection box 56 are routed to the upper cross member 28 containing the toggle switch 64 so as to allow the motor 62 to be operated in either a forward or reverse direction.

Turning now to FIG. 5, there is shown a partial cross-sectional view of a typical stepper motor of the type utilized as motor assembly 62. A conventional stepper motor includes an electrical drive motor 90 that may be operated in either a forward or reverse direction. An output shaft of the motor 90 is connected to drive mechanism 62A that comprises a plurality of drive gears illustrated generally at 92 to form a gear box that reduces the speed of the motor shaft to a suitable drive speed for driving a screw type gear 94 coupled to output shaft 66. The screw 94 is coupled in a conventional manner to the shaft 66 to enable shaft 66 to move in and out of the motor drive mechanism 62A as the motor shaft rotates.

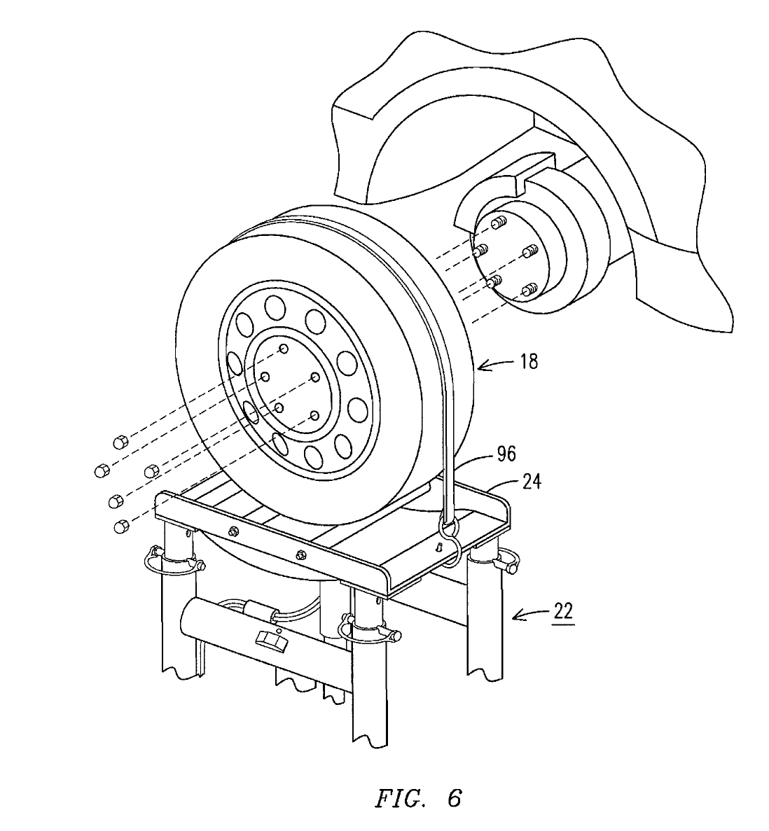

FIG. 6 illustrates the use of an elastic cord 96 to hold a wheel 18 onto the platform 24. The cord 96 may not be necessary but does provide a degree of safety to prevent the wheel from falling off of the platform while the platform is being moved to or from the vehicle 12.

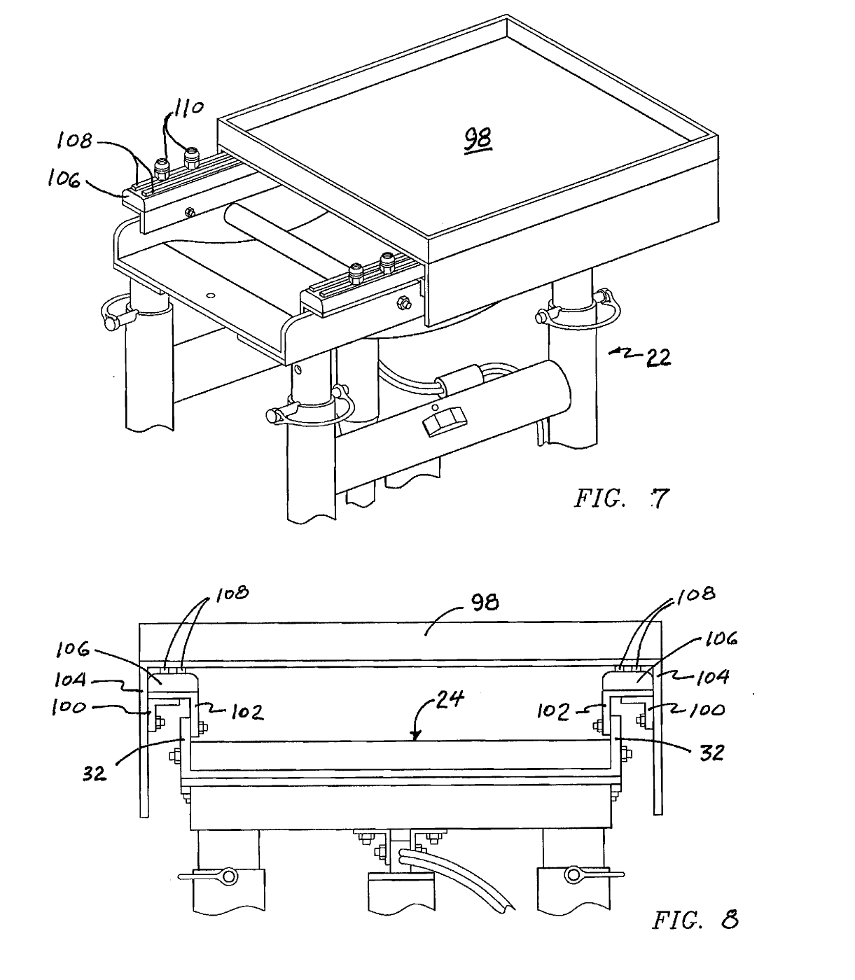

FIG. 7 is a partial top perspective view of the dolly 22 illustrating a sliding tray 98 that can be used with the dolly to support objects other than a wheel. For example, the tray 98 may be used to transport other automotive parts or to place tools while working around a vehicle. FIG. 8 is a front view of the tray 98 on the dolly 22 showing how the tray is provided with guide supports 100 that engage with runners 102 on dolly 22. In a simple form, the runners 102 are “angle irons” with an L-shaped cross section. The runners are fastened to the upper side plates 32 of the dolly such as by bolts, rivets or welding with one arm of each L-shaped runner extending outwardly from the side plates 32. The guide supports 100 may also be angle irons of the same configuration that are fastened to side plates 104 of the tray 98. The supports 100 are oriented reversibly from the runners 102 so that one arm of the L-shaped support extends under the outwardly extending arm of the runners. The top of the runners 102 are provided with a plastic surface 106 to facilitate sliding motion of the tray on the runners. In addition, the surface 106 may incorporate magnetic strips 108 that can be used to retain small items such as nuts 110 to prevent them from being misplaced while working on a vehicle.

What is claimed is:

1. A wheeled dolly adapted for transport and support of a vehicle wheel comprising:
a base unit having a plurality of vertical, tubular support posts, each of the posts terminating in a roller arranged to allow the base unit to be moved across a surface;
a platform adjustably attached to a top of the base unit, the platform including a plurality of downwardly extending tubular posts sized and positioned to telescopically engage the support posts of the base unit, a top of the platform being configured to support a vehicle tire in an upright position;
an electric motor and drive mechanism coupled between the platform and the base unit, the motor and drive mechanism arranged to advance and retract the platform a predetermined distance, the drive mechanism having a telescopic coupling to one of the platform and base unit, the telescopic coupling being adjustable by alignment of one of multiple holes through which a pin can be inserted; and
the tubular posts being fixed in selected telescopic positions by means of pins inserted through holes in the posts, whereby the platform can be raised and lowered in a stepwise manner by alternately changing the platform position with the motor and moving the pins to other locations.

2. The dolly of claim 1 and including a pair of rollers extending transversely of the platform for supporting a vehicle wheel placed on the platform such that the vehicle wheel can be rotated about its axis.

3. The dolly of claim 1 wherein the electric motor is attached to the platform and the drive mechanism includes a gear driven shaft coupled to the base unit.

4. The dolly of claim 3 wherein the telescopic coupling comprises a tubular member slidably engaged in a cross brace support of the base unit, the tubular member having a plurality of transverse holes for passing of a pin therethrough, the pin having a length sufficient to prevent passage through the cross brace support, the gear driven shaft being pinned to the tubular member whereby actuation of the motor in a forward direction effects elevation of the platform as the shaft extends from the drive mechanism and reacts against the cross brace member.

5. The dolly of claim 1 and including a slidable tray removably positioned on top of the platform.
